(19) United States
(12) Patent Application Publication
(10) Pub. No.: US 2026/0001280 A1
(43) Pub. Date: Jan. 1, 2026

(54) METHODS FOR ADDITIVE MANUFACTURING WITH REDUCED SUPPORTS

(71) Applicant: Align Technology, Inc., San Jose, CA (US)

(72) Inventors: Peter Dorfinger, Woodside, CA (US); Michael Christopher Cole, San Jose, CA (US); Viswanath Meenakshisundaram, Santa Clara, CA (US); Srinivas Kaza, Mountain View, CA (US); Christopher Carner, Apex, NC (US); Simone Rossi, Durham, NC (US); Richal Abhang, Milpitas, CA (US)

(21) Appl. No.: 19/253,143

(22) Filed: Jun. 27, 2025

Related U.S. Application Data
(60) Provisional application No. 63/665,959, filed on Jun. 28, 2024.

(51) Int. Cl. B29C 64/40; B29C 64/386; B29L 31/00; B33Y 10/00; B33Y 50/00; B33Y 80/00

(52) U.S. Cl. CPC B29C 64/40; B29C 64/386; B33Y 10/00; B33Y 50/00; B33Y 80/00; B29L 2031/753

(57) ABSTRACT

Methods and systems for additive manufacturing of objects are provided. In some embodiments, a method includes receiving a digital representation of an object to be fabricated via an additive manufacturing process; identifying an internal portion of the object that would be unstable during the additive manufacturing process without an internal support structure, based on the digital representation; modifying the digital representation of the object to remove at least part of the internal portion; and generating instructions for fabricating the object via the additive manufacturing process, based on the modified digital representation.

### CROSS-REFERENCE TO RELATED APPLICATION(S)

The present application claims the benefit of priority to U.S. Provisional Application No. 63/665,959, filed Jun. 28, 2024, which is incorporated by reference herein in its entirety.

### TECHNICAL FIELD

The present technology generally relates to manufacturing, and in particular, to methods for additive manufacturing with reduced supports.

### BACKGROUND

Additive manufacturing encompasses a variety of technologies that involve building up 3D objects from multiple layers of material. In some instances, support structures are added to the object during the additive manufacturing process to secure the object to the build platform, support unstable features, improve printing accuracy, or avoid stress-induced deformation. Typically, the support structures are broken off or otherwise manually removed from the object after fabrication, which can be time-consuming, inefficient for large scale manufacturing, presents a risk of damaging the object, and may leave unaesthetic blemishes on the object. Moreover, support structures that are located at internal portions of the object may be challenging to remove or may leave residual fragments that interfere with the aesthetics or function of the object.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram providing a general overview of a method for fabricating and post-processing an additively manufactured object, in accordance with embodiments of the present technology.

FIG. 2 is a partially schematic diagram providing a general overview of an additive manufacturing process, in accordance with embodiments of the present technology.

FIG. 3A is a side cross-sectional view of a dental appliance that may be fabricated using an additive manufacturing process.

FIG. 3B is a top cross-sectional view of the dental appliance of FIG. 3A.

FIG. 4A is a top perspective view of a dental appliance with internal support structures.

FIG. 4B is a bottom perspective view of the dental appliance of FIG. 4A.

FIGS. 5A-5D are partially schematic illustrations of a portion of an additively manufactured dental appliance with an internal support structure.

FIG. 6 is a photograph of an additively manufactured dental appliance including support structure residue within the appliance cavities.

FIGS. 7A and 7B are partially schematic side cross-sectional views of an additively manufactured object before (FIG. 7A) and after (FIG. 7B) modifications to reduce or omit internal support structures, in accordance with embodiments of the present technology.

FIGS. 8A-8C are bottom perspective views of a dental appliance before (FIGS. 8A and 8B) and after (FIG. 8C) modifications to avoid internal support structures, in accordance with embodiments of the present technology.

FIGS. 9A-9C are partially schematic side cross-sectional views of an additively manufactured object before (FIG. 9A) and after (FIGS. 9B and 9C) modifications to reduce residue left by internal support structures, in accordance with embodiments of the present technology.

FIGS. 10A and 10B are partially schematic side cross-sectional views of an additively manufactured object 1000 before (FIG. 10A) and after (FIG. 10B) modifications to compensate for removed material, in accordance with embodiments of the present technology.

FIG. 11 is a perspective view of a portion of a dental appliance with modifications in accordance with embodiments of the present technology.

FIG. 12 is a perspective view of a portion of a dental appliance with modifications in accordance with embodiments of the present technology.

FIG. 13 is a flow diagram illustrating a method for designing and fabricating an additively manufactured object, in accordance with embodiments of the present technology.

FIG. 14 illustrates identification and deletion of islands in a digital representation of a dental appliance, in accordance with embodiments of the present technology.

FIGS. 15A and 15B illustrate a digital representation of a dental appliance before (FIG. 15A) and after (FIG. 15B) modifications to delete islands, in accordance with embodiments of the present technology.

FIGS. 16A and 16B illustrate a digital representation of a dental appliance before (FIG. 16A) and after (FIG. 16B) modifications to delete overhangs, in accordance with embodiments of the present technology.

FIGS. 17A and 17B illustrate a digital representation of a dental appliance before (FIG. 17A) and after (FIG. 17B) modifications to eliminate disconnected overhangs, in accordance with embodiments of the present technology.

FIG. 18 is a flow diagram illustrating a method for modifying a digital representation of an object, in accordance with embodiments of the present technology.

FIG. 19 is a flow diagram illustrating a method for designing and fabricating dental appliance, in accordance with embodiments of the present technology.

FIGS. 20A-20C illustrate a workflow for modifying a digital representation of a patient's teeth, in accordance with embodiments of the present technology.

FIG. 21A illustrates a representative example of a tooth repositioning appliance configured in accordance with embodiments of the present technology.

FIG. 21B illustrates a tooth repositioning system including a plurality of appliances, in accordance with embodiments of the present technology.

FIG. 21C illustrates a method of orthodontic treatment using a plurality of appliances, in accordance with embodiments of the present technology.

FIG. 22 illustrates a method for designing an orthodontic appliance, in accordance with embodiments of the present technology.

FIG. 23 illustrates a method for digitally planning an orthodontic treatment and/or design or fabrication of an appliance, in accordance with embodiments of the present technology.

### DETAILED DESCRIPTION

The present technology relates to methods and systems for additive manufacturing. In some embodiments, for example, a method includes receiving a digital representation of an object to be fabricated via an additive manufacturing process, such as a dental appliance. The method can include identifying an internal portion of the object that would be unstable during the additive manufacturing process without an internal support structure, based on the digital representation. For example, the internal portion can be an overhang or valley that would deform or collapse if left unsupported during the additive manufacturing process, or that is otherwise unprintable without support structures. The method can further include modifying the digital representation of the object to remove at least part of the internal portion. In some embodiments, the internal portion is completely removed so that the object can be printed without any internal support structures for the internal portion. In other embodiments, the internal portion is partially removed so that an internal support structure used to support the internal portion during printing can be broken off without leaving large fragments that would interfere with the function of the object. The method can include generating instructions for fabricating the object via the additive manufacturing process, based on the modified digital representation.

As another example, a method can include receiving a digital representation of a patient's teeth, and identifying a region of the digital representation of the patient's teeth corresponding to an unstable internal portion of a dental appliance for the patient's teeth (e.g., an overhang, valley, etc., that would deform or collapse if left unsupported during an additive manufacturing process, or that is otherwise unprintable without support structures). The method can further include modifying the region in the digital representation of the patient's teeth, e.g., to eliminate the unstable internal portion or to ensure that residue from any internal support structures at the internal portion do not interfere with fitting of the dental appliance on the patient's teeth. The method can also include generating a digital representation of the dental appliance, based on the digital representation of the patient's teeth with the modified region, and generating instructions for fabricating the dental appliance via an additive manufacturing process, based on the digital representation of the dental appliance.

The present technology can provide many advantages compared to conventional approaches for designing support structures for additively manufactured objects. For instance, the techniques described herein can allow objects with complex geometries such as dental appliance to be printed with few or no internal support structures, thereby simplifying the support structure removal process, reducing the need for manual polishing steps, and/or reducing the likelihood that the final object will include residual support structure fragments that may interfere with the aesthetics and/or function of the object. Accordingly, additively manufactured objects can be produced on an industrial scale with reduced time and labor costs.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

I. Methods and Systems for Additive Manufacturing with Reduced Internal Support Structures

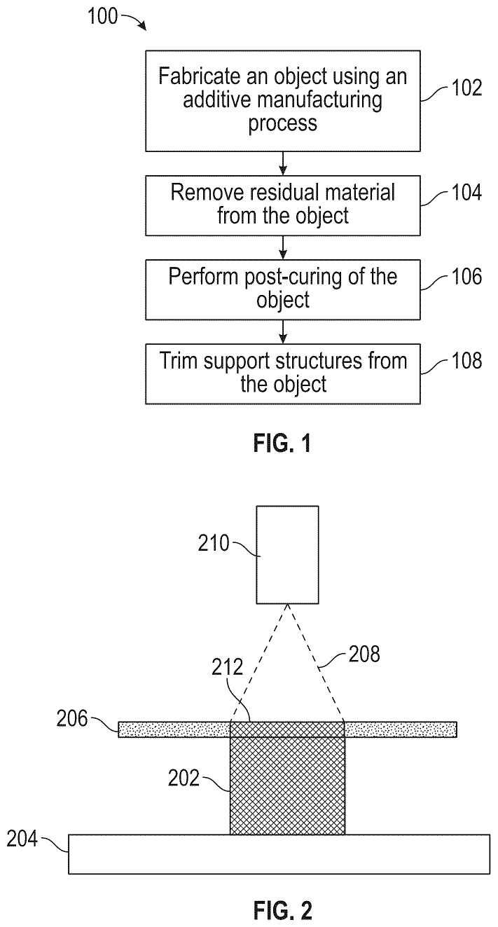

FIG. 1 is a flow diagram providing a general overview of a method 100 for fabricating and post-processing an additively manufactured object, in accordance with embodiments of the present technology. The method 100 can be used to produce many different types of additively manufactured objects, such as orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section II below.

The method 100 begins at block 102 with fabricating an object on a build platform using an additive manufacturing process. The additive manufacturing process can implement any suitable technique known to those of skill in the art. Additive manufacturing (also referred to herein as “3D printing”) includes a variety of technologies which fabricate 3D objects directly from digital models through an additive process. In some embodiments, additive manufacturing includes depositing a precursor material onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,624 and U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Pat. No. 10,162,264 and U.S. Patent Publication No. 2014/0265034, the disclosures of which are incorporated herein by reference in their entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

After the additively manufactured object is fabricated, the object can undergo one or more additional process steps, also referred to herein as “post-processing.” As described in detail below with respect to blocks 104-108, post-processing can include removing residual material from the object, performing post-curing of the object, and/or trimming support structures from the object.

For example, at block 104, the method 100 can continue with removing residual material from the object. The excess material can include excess precursor material (e.g., uncured resin) and/or other unwanted material (e.g., debris) that remains on or within the object after the additive manufacturing process. The residual material can be removed in many different ways, such as by exposing the object to a solvent (e.g., via spraying, immersion), heating or cooling the object, applying a vacuum to the object, blowing a pressurized gas onto the object, applying mechanical forces to the object (e.g., vibration, agitation, centrifugation, tumbling, brushing), and/or other suitable techniques. Optionally, the residual material can be collected and/or processed for reuse.

At block 106, the method 100 can optionally include post-curing the object. Post-curing is an additional curing process that can be used in situations where the object is still in a partially cured “green” state after fabrication. For example, the energy used to fabricate the object in block 102 may only partially polymerize the precursor material forming the object. Accordingly, the post-curing step may be needed to fully cure (e.g., fully polymerize) the object to its final, usable state. Post-curing can provide various benefits, such as improving the mechanical properties (e.g., stiffness, strength) and/or temperature stability of the object. Post-curing can be performed by heating the object, applying radiation (e.g., UV, visible, microwave) to the object, or suitable combinations thereof. In other embodiments, however, the post-curing process of block 106 is optional and can be omitted.

At block 108, the method 100 can include trimming support structures from the object. In some embodiments, the object includes support structures (e.g., struts, cones, rods, pins, arms, bridges, crossbars, blocks) that connect the object to the build platform. The support structures can provide mechanical support for one or more portions of the object, such as overhangs, bridges, islands, valleys, and/or other components that would deform or collapse without such support. Support structures can also be used to reinforce the object to reduce the likelihood of bending, warping, or other undesirable changes to the object geometry during post-processing (e.g., due to forces applied during centrifugation, exposure to solvents, changes in temperature, etc.). The support structures are typically not intended to be part of the final product, and thus may need to be removed from the rest of the object during post-processing.

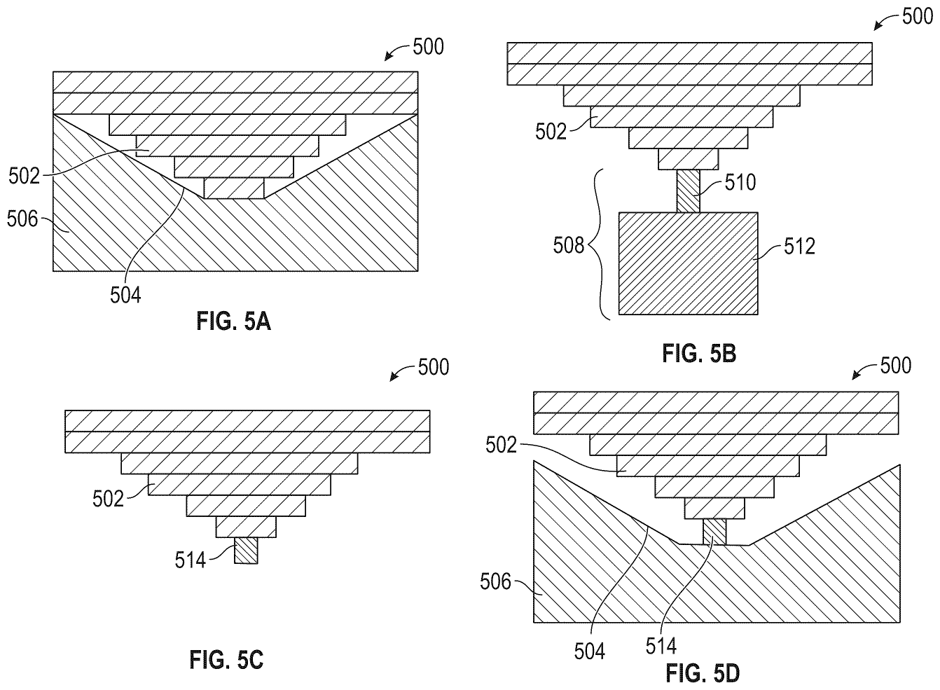

The process of removing support structures from the object (also referred to herein as “trimming” support structures from the object) can be performed using various techniques, such as mechanical forces (e.g., scraping, cutting, breaking), energy (e.g., cutting via a laser), exposure to conditions that weaken and/or degrade the support structures (e.g., solvents, high or low temperatures), or suitable combinations thereof. Trimming may be performed using an automated system, manually by a human operator, or suitable combinations thereof. In some embodiments, residual fragments of the support structures may remain on the object after trimming. Such fragments may be left on the object, or may be removed through polishing or other surface modification techniques. In some embodiments, the additively manufactured objects herein are designed so that the object includes few or no internal support structures that need to be removed during the trimming process of block 108, e.g., as described further below in connection with FIGS. 5-20C

The method 100 illustrated in FIG. 1 can be modified in many different ways. For example, although the above steps of the method 100 are described with respect to a single object, the method 100 can be used to sequentially or concurrently fabricate and post-process any suitable number of objects, such as tens, hundreds, or thousands of additively manufactured objects. As another example, the ordering of the processes shown in FIG. 1 can be varied (e.g., the process of block 108 can be performed before and/or concurrently with the processes of blocks 104 and/or 106). Some of the processes of the method 100 can be omitted, such as the process of block 106. Additionally, the method 100 can include processes not shown in FIG. 1, such as cleaning the object (e.g., washing, solvent extraction), annealing the object, separating the object from a build platform, performing surface modifications and/or treatments, and/or packaging the object for shipment.

FIG. 2 is a partially schematic diagram providing a general overview of an additive manufacturing process, in accordance with embodiments of the present technology. Additive manufacturing (also referred to herein as “3D printing”) includes a variety of technologies which fabricate 3D objects directly from digital models through an additive process. For example, additive manufacturing can be used to directly fabricate orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section II below.

In some embodiments, additive manufacturing includes depositing a precursor material (e.g., a polymeric resin) onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

For example, in the embodiment of FIG. 2, an object 202 is fabricated on a build platform 204 from a series of cured material layers, with each layer having a geometry corresponding to a respective cross-section of the object 202. To fabricate an individual object layer, a layer of curable material 206 (e.g., polymerizable resin) is brought into contact with the build platform 204 (when fabricating the first layer of the object 202) or with the previously formed portion of the object 202 on the build platform 204 (when fabricating subsequent layers of the object 202). In some embodiments, the curable material 206 is formed on and supported by a substrate (not shown), such as a film. Energy 208 (e.g., light) from an energy source 210 (e.g., a laser, projector, or light engine) is then applied to the curable material 206 to form a cured material layer 212 on the build platform 204 or on the object 202. The remaining curable material 206 can then be moved away from the build platform 204 (e.g., by lowering the build platform 204, by moving the build platform 204 laterally, by raising the curable material 206, and/or by moving the curable material 206 laterally), thus leaving the cured material layer 212 in place on the build platform 204 and/or object 202. The fabrication process can then be repeated with a fresh layer of curable material 206 to build up the next layer of the object 202.

The illustrated embodiment shows a “top down” configuration in which the energy source 210 is positioned above and directs the energy 208 down toward the build platform 204, such that the object 202 is formed on the upper surface of the build platform 204. Accordingly, the build platform 204 can be incrementally lowered relative to the energy source 210 as successive layers of the object 202 are formed. In other embodiments, however, the additive manufacturing process of FIG. 2 can be performed using a “bottom up” configuration in which the energy source 210 is positioned below and directs the energy 208 up toward the build platform 204, such that the object 202 is formed on the lower surface of the build platform 204. Accordingly, the build platform 204 can be incrementally raised relative to the energy source 210 as successive layers of the object 202 are formed.

Although FIG. 2 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

As discussed above, an additively manufactured object can be fabricated with one or more support structures that connect the object to the build platform and/or provide mechanical support for the object during fabrication and/or post-processing. Some or all of the support structures may need to be trimmed from the object before the object is ready for use. However, certain types of support structures, such as internal support structures, may be challenging to trim from the object without leaving residue that may interfere with the aesthetics and/or function of the object.

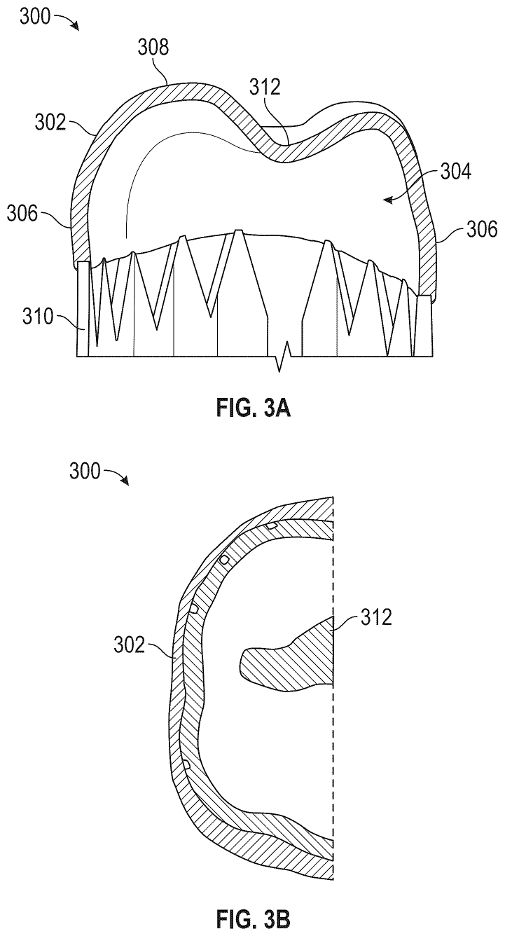

For example, FIGS. 3A and 3B are side and top cross-sectional views, respectively, of a dental appliance 300 that may be fabricated using an additive manufacturing process. The appliance 300 can include a shell 302 defining a plurality of cavities 304 for receiving a patient's teeth. As best seen in FIG. 3A, the appliance 300 can be additively manufactured in a “cutline down” configuration in which the gingival edges 306 of the shell 302 are oriented downward toward the build platform (not shown) and the occlusal surfaces 308 of the shell 302 are oriented upward away from the build platform. In such embodiments, the gingival edges 306 of the shell 302 can be connected to the build platform via a plurality of support structures 310. This configuration can be advantageous, for example, for reducing printing time and/or for avoiding warping of the gingival portions of the shell 302 during post-processing. For instance, heated centrifugation can be more efficient for removal of residual resin than other cleaning techniques and/or may obviate the need for additional post-processing steps to remove resin such as washing with water or solvents, but may place greater mechanical stresses on the appliance 300, particularly the gingival portions, which may be more flexible and thus more prone to warping unless stabilized by the support structures 310.

When the appliance 300 is in a cutline down configuration, certain internal portions of the appliance 300 may require support structures to be printable. For instance, as shown in FIG. 3B, valleys 312 in the occlusal surface 308 of the appliance 300 that extend downward toward the interior of the cavity 304 may form islands that are disconnected from the rest of the shell 302 when the appliance geometry is sliced into 2D cross-sections for printing via a layer-by-layer additive manufacturing process. Such islands may be challenging or impossible to print unless supported by an internal support structure that is connected to the internal surface of the valley 312 to the build platform. Alternatively or in combination, internal support structures may be needed if the occlusal surface 308 includes long spans (e.g., overhangs) that are connected to the rest of the shell but may sag, deform, or otherwise be challenging or impossible to print unless supported from below by an internal support structure.

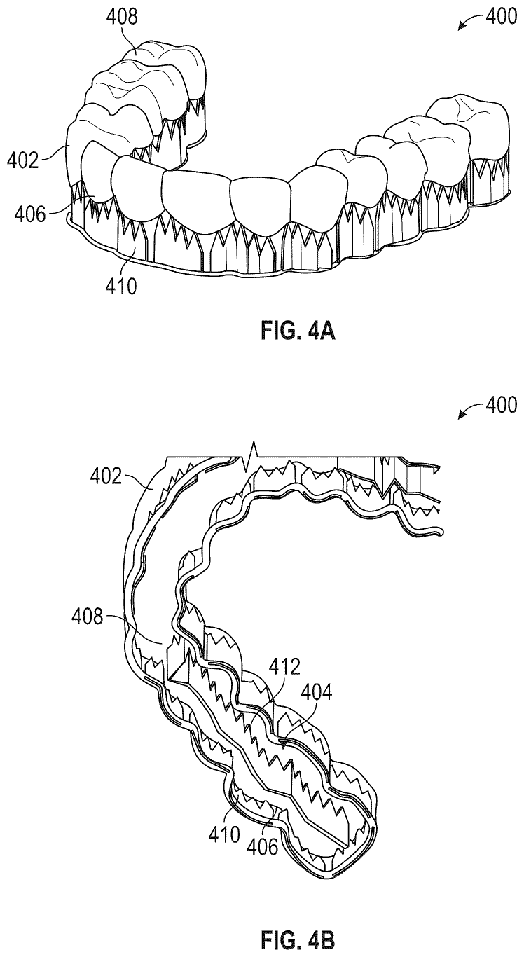

FIGS. 4A and 4B are top and bottom perspective views, respectively, of a dental appliance 400 with internal support structures. Similar to the appliance 300 of FIGS. 3A and 3B, the appliance 400 can include a shell 402 defining a plurality of cavities 404 for receiving a patient's teeth, and can be printed in a cutline down configuration with the gingival edges 406 of the shell 402 facing downward toward the build platform (not shown) and the occlusal surfaces 408 of the shell 402 facing upward away from the build platform. The appliance 400 can be connected to the build platform via a plurality of support structures 410 at the gingival edges 406 of the shell 402. Moreover, as best seen in FIG. 4B, the internal surface of the concavities in the occlusal surface 408 of the shell 402 can be connected to the build platform via a plurality of internal support structures 412. The internal support structures 412 can be positioned partially or entirely within the cavities 404 of the shell 402, which may make it challenging to completely trim the internal support structures 412 from the appliance 400 during post-processing.

FIGS. 5A-5D are partially schematic illustrations of a portion of an additively manufactured dental appliance 500 with an internal support structure. Referring first to FIG. 5A, the appliance 500 can be designed to include an internal portion 502 with a concave shape that conforms closely to the contours of the corresponding occlusal surface 504 of a received tooth 506. For instance, the tooth 506 can be a molar or premolar having pits and/or fissures in the occlusal surface 504, and the internal portion 502 can include concavities formed therein corresponding to the pits and/or fissures.

As shown in FIG. 5B, the internal portion 502 can be supported during the additive manufacturing process by one or more internal support structures 508. Each internal support structure 508 can include a connection region 510 that is attached to the lowest point of the internal portion 502, and a base 512 extending from the connection region 510 and coupled to the build platform (not shown).

As shown in FIG. 5C, during post-processing of the appliance 500, the internal support structure 508 can be fractured to separate the appliance 500 from the build platform. However, the fracturing of the internal support structure 508 can leave residue (e.g., a fragment of the connection region 510) on the appliance 500, e.g., due to the design of the internal support structure 508 and/or challenges in accessing and trimming the internal support structure 508.

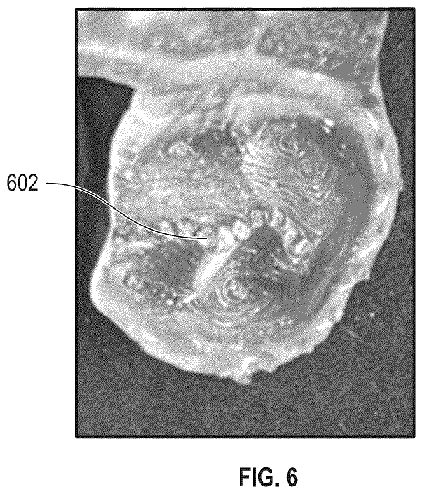

As shown in FIG. 5D, if the residue 514 is too large, it may come into contact with the occlusal surface 504 of the tooth 506 and thereby interfere with proper fitting of the appliance 500 and/or cause patient discomfort. Moreover, support structure residue left within the internal portions of the appliance 500 may be visually undesirable, e.g., as shown in FIG. 6, which is a photograph of an additively manufactured dental appliance including support structure residue 602 within the appliance cavities.

To address these and other challenges, the present technology provides methods for designing additively manufactured objects such as dental appliances to reduce or obviate the need for internal support structures (e.g., support structures that are connected to an internal portion of the object and/or are located partially or entirely within an internal cavity of the object). In some embodiments, the methods herein are used to design additively manufactured objects that may be printed without any internal support structures. Alternatively, the methods herein can be used to design additively manufactured objects that may require some internal support structures for printing, but the internal support structures can be trimmed without leaving residue that interferes with the function of the object.

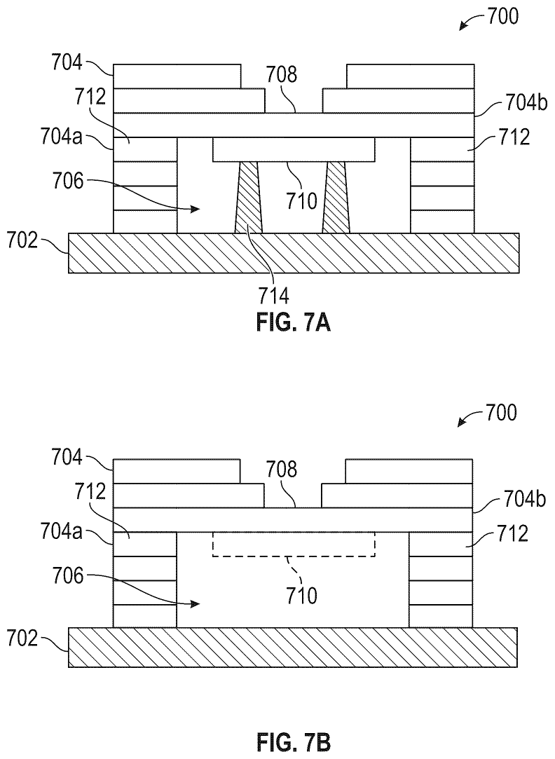

FIGS. 7A and 7B are partially schematic side cross-sectional views of an additively manufactured object 700 before (FIG. 7A) and after (FIG. 7B) modifications to reduce or omit internal support structures, in accordance with embodiments of the present technology. Referring first to FIG. 7A, the object 700 (e.g., a dental appliance) can be fabricated on a build platform 702 from a plurality of layers 704 of material via a layer-by-layer additive manufacturing process, such as SLA, DLP, etc. For example, the layer-by-layer additive manufacturing process can involve sequentially curing selected portions of a curable material layer to form the layers 704, with each layer 704 corresponding to a respective cross-sectional portion (e.g., slice) of the object geometry.

In the illustrated embodiment, the object 700 includes an internal cavity 706 and a valley 708 extending downward into the internal cavity 706. For instance, in embodiments where the object 700 is a dental appliance, the valley 708 can correspond to a concavity in the occlusal surface of the dental appliance. The internal portion of the valley 708 (e.g., the lowermost portions within the internal cavity 706) may need to be stabilized with internal support structures 714 in order to be printable. As shown in FIG. 7A, the internal portion can correspond to at least an internal region 710 of an object layer 704a that is not connected to the remaining external regions 712 of the same layer 704a and is also not connected to any previous object layers 704 that could support the internal region 710 from below. Accordingly, the internal region 710 forms an island that is unprintable unless supported by internal support structures 714 that connect the internal region 710 to the build platform 702. Alternatively, the internal support structures 714 may be needed if the internal region 710 is connected to the external regions 712 of the same layer 704a, but the length of the internal region 710 is too long to be printed without being supported from below by the internal support structures 714 (e.g., the overhang length of the internal region 710 exceeds the maximum overhang length for the particular additive manufacturing process). However, because the internal support structures 714 are partially or entirely within the internal cavity 706 of the object 700, the internal support structures 714 may be difficult to remove during post-processing and/or may leave residue within the internal cavity 706 that could interfere with the function of the object 700 (e.g., interfere with appliance fit).

Referring next to FIG. 7B, the geometry of the object 700 can be modified to at least partially remove the internal portion of the valley 708 that requires stabilization, thereby obviating the need for the internal support structures 714. In the illustrated embodiment, the internal region 710 of the layer 704a has been removed (indicated by broken lines), such that the modified layer 704a only includes the external regions 712 that are adequately supported by underlying object layers 704. The next object layer 704b above the layer 704a can remain unmodified, since all regions of the next layer 704b are sufficiently connected to each other and/or to the previous layer 704a and thus do not require internal support structures. Accordingly, the modified object 700 can be printed without requiring the internal support structures 714 to stabilize the valley 708.

Although FIGS. 7A and 7B illustrate a modification involving removal of the internal region 710 of a single layer 704 of the object 700, in other embodiments, the internal regions 710 of multiple layers 704 can be removed to reduce or obviate the need for internal support structures 714. The number of layers 704 to be modified and the locations of the modifications can be varied as appropriate, e.g., depending on the object geometry, expected impacts on object function and/or properties, characteristics of the additive manufacturing process, etc.

The modifications described with respect to FIGS. 7A and 7B can be used, for example, in situations where complete removal of the lowermost portion of the valley 708 is not expected to substantially impact the function and/or properties of the object 700. For instance, in embodiments where the object 700 is a dental appliance and the valley 708 corresponds to the occlusal surface of the appliance, complete removal of the lowermost portion of the valley 708 may be appropriate if the appliance does not need to exert significant forces on the occlusal surface of the corresponding tooth to achieve its therapeutic effect, if the appliance is designed so that the lowermost portion of the valley 708 does not contact the tooth, and/or if thinning the occlusal surface of the appliance does not substantially affect the integrity, aesthetics, and/or mechanical properties of the appliance.

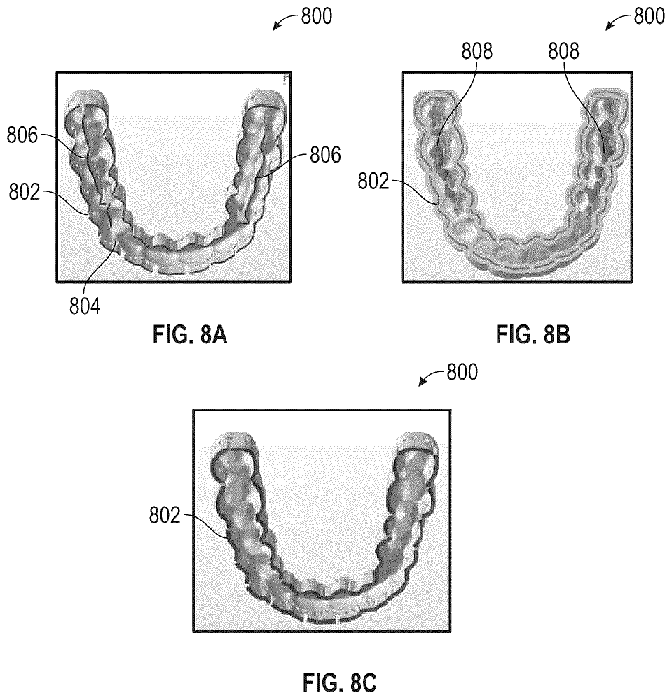

FIGS. 8A-8C are bottom perspective views of a dental appliance 800 before (FIGS. 8A and 8B) and after (FIG. 8C) modifications to avoid internal support structures, in accordance with embodiments of the present technology. Referring first to FIG. 8A, the appliance 800 includes a shell 802 including occlusal surfaces 804 with valleys corresponding to the pits and fissures on the occlusal surfaces of the corresponding received teeth. The internal portions of the valleys may need to be supported with internal support structure 806 in order to be printable, as discussed elsewhere herein.

The geometry of the appliance 800 can be modified to reduce or eliminate the internal support structures 806. For instance, as shown in FIG. 8B, the appliance geometry can be analyzed to identify the internal portions 808 of the occlusal surfaces 804 that form disconnected islands when the appliance 800 is sliced into individual layers and thus require support. The internal portions 808 may generally correspond to the lowermost portions of the valleys 708. As shown in FIG. 8C, these internal portions 808 can be partially or entirely removed from the appliance geometry, such that the appliance 800 can be printed without some or all of the internal support structures 806. As a result of removing the internal portions 808, the internal surfaces of the valleys may be flattened out and have a substantially planar internal surface profile. Accordingly, the shell 802 may generally conform to the contours of the received teeth, except for the lowermost points of the valleys which are flattened out rather than matching the topography of the occlusal surfaces of the teeth.

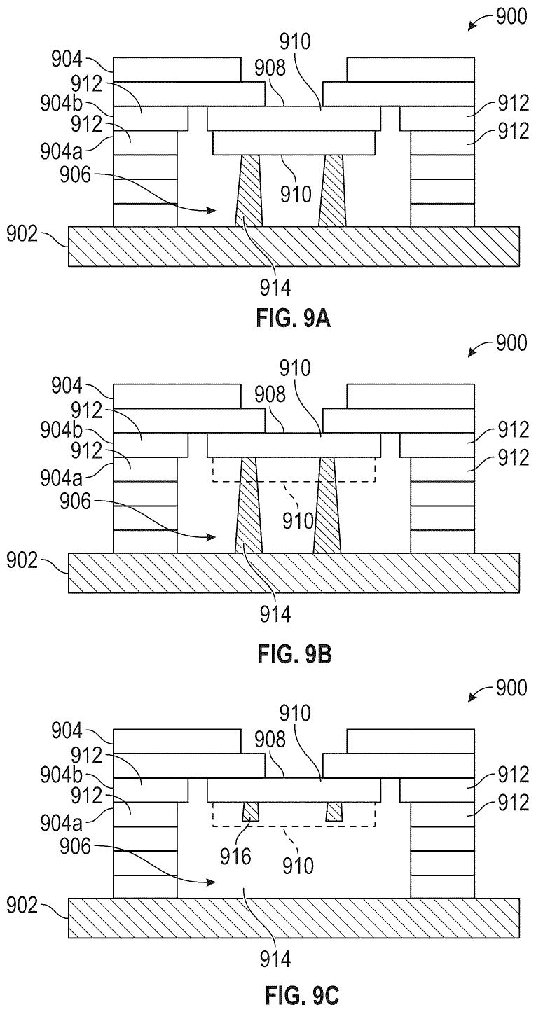

FIGS. 9A-9C are partially schematic side cross-sectional views of an additively manufactured object 900 before (FIG. 9A) and after (FIGS. 9B and 9C) modifications to reduce residue left by internal support structures, in accordance with embodiments of the present technology. The object 900 may be identical or generally similar to the object 700 of FIGS. 7A and 7B. Accordingly, like numbers (e.g., valley 908 and 708) are used to refer to identical or similar elements, and the discussion of the embodiments of FIGS. 9A-9C will be limited to those features that are different from the embodiments of FIGS. 7A and 7B.

Referring first to FIG. 9A, the object 900 (e.g., a dental appliance) can be fabricated on a build platform 902 from a plurality of layers 904 of material via a layer-by-layer additive manufacturing process. The object 900 can include an internal cavity 906 and a valley 908 extending downward into the internal cavity 906. The valley 908 may need to be supported by internal support structures 914 in order to be printable. For instance, as shown in FIG. 9A, due to the presence of the valley 908, the object 900 includes a first layer 904a and a second layer 904b that each have an internal region 910 that is not connected to the remaining external regions 912 of the same layer and is also not connected to any previous object layers 904 that could support the internal region 910 from below (the internal region 910 of the first layer 904a already lacks sufficient support and thus cannot support the internal region 910 of the second layer 904b). Alternatively, the internal region 910 may require support even if the internal region 910 is connected to the external regions 912 of the same layer, but the overhang length of the internal region 910 is too to be printed without being supported from below.

Referring next to FIG. 9B, the geometry of the object 900 can be modified to partially remove the internal portion of the valley 908 that requires stabilization, such that the internal support structures 914 used to support the remaining internal portion of the valley 908 is not expected to leave residue that interferes with the function of the object 900. In the illustrated embodiment, the internal region 910 of the first layer 904a has been removed (indicated by broken lines), such that the modified first layer 904a only includes the external regions 912 that are adequately supported by underlying object layers 904. However, the second layer 904b above the first layer 904a can remain unmodified, even though the internal region 910 of the second layer 904b is still insufficiently supported and may still require the internal support structures 914 to be printed.

Referring next to FIG. 9C, the modified object 900 can be printed with the internal support structures 914 to support the valley 908. After printing, the internal support structures 914 can be at least partially removed, e.g., by fracturing or otherwise trimming the internal support structures 914 from the object 900. In some instances, the removal process may leave support structure residue 916 on the object 900 (e.g., fragments of the internal support structures 914 that were broken off from the rest of the internal support structures 914). However, the size of the residue 916 can be sufficiently small such that the presence of the residue 916 is not expected to interfere with the function of the object 900. For example, in embodiments where the object 900 is a dental appliance, the height of the residue 916 can be sufficiently small such that the residue 916 does not contact the corresponding tooth when the appliance is worn.

As shown in FIG. 9C, this effect can be achieved, for example, if the height of the residue 916 is less than the height of the removed internal region 910 of the first layer 904. The height of the residue 916 may be controlled based on the design of the internal support structures 914, e.g., the internal support structures 914 can include narrowed regions, perforations, necking, etc., to ensure that the internal support structures 914 break predictably at a consistent location to leave residue 916 of a predetermined height (e.g., no more than 2 mm, 1 mm, 0.5 mm, 0.2 mm, or 0.1 mm).

Although FIGS. 9A-9C illustrate a modification involving removal of the internal region 910 of a single layer 904 of the object 900, in other embodiments, the internal regions 910 of multiple layers 904 can be removed to ensure that the support structure residue 916 does not interfere with the object function, e.g., if the height of the residue 916 is expected to be greater than the height of an individual layer 904 and/or to provide a greater safety margin of clearance between the dental appliance and the received tooth. The number of layers 904 to be modified and the locations of the modifications can be varied as appropriate, e.g., depending on the object geometry, expected impacts on object function and/or properties, characteristics of the additive manufacturing process, layer height, expected size of the support structure residue 916, etc.

The modifications described with respect to FIGS. 9A-9C can be used, for example, in situations where complete removal of the lowermost portion of the valley 908 is not possible or is undesirable, e.g., if complete removal might detrimentally impact the function and/or properties of the object 900, and/or if the objective is to preserve as much of the original object geometry as possible. For instance, in embodiments where the object 900 is a dental appliance and the valley 908 corresponds to the occlusal surface of the appliance, complete removal of the lowermost portion of the valley 908 may be undesirable if the appliance exerts forces on the occlusal surface of the corresponding tooth to achieve its therapeutic effect, and/or if thinning the occlusal surface of the appliance may affect the integrity, aesthetics, and/or mechanical properties of the appliance. Alternatively or in combination, the modifications of FIGS. 9A-9C can be used if it is functionally and aesthetically acceptable to leave some support structure residue 916 on the final object 900 and/or if such residue 916.

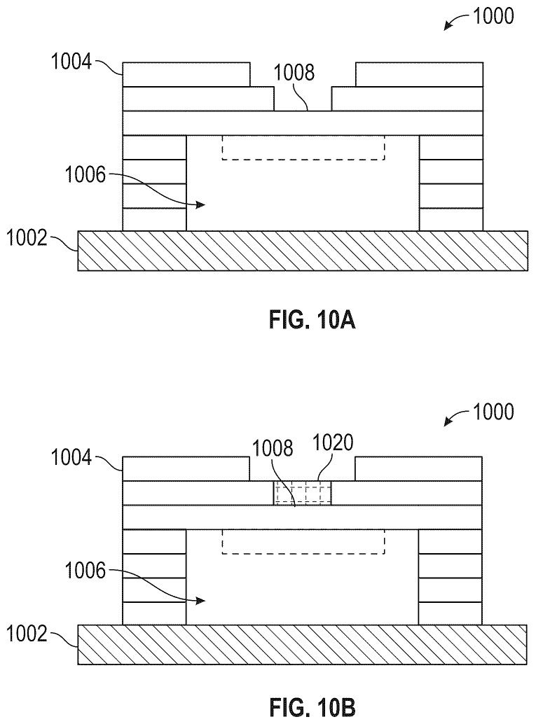

FIGS. 10A and 10B are partially schematic side cross-sectional views of an additively manufactured object 1000 before (FIG. 10A) and after (FIG. 10B) modifications to compensate for removed material, in accordance with embodiments of the present technology. The object 1000 may be identical or generally similar to the object 700 of FIGS. 7A and 7B and/or the object 900 of FIGS. 9A-9C. Accordingly, like numbers (e.g., valley 1008 and 708) are used to refer to identical or similar elements, and the discussion of the embodiments of FIGS. 9A-9C will be limited to those features that are different from the embodiments of FIGS. 7A and 7B.

Referring first to FIG. 10A, the object 1000 (e.g., a dental appliance) can be fabricated on a build platform 1002 from a plurality of layers 1004 of material via a layer-by-layer additive manufacturing process. The object 1000 can include an internal cavity 1006 and a valley 1008 extending downward into the internal cavity 1006. To reduce or obviate the need for internal support structures and/or to ensure that residue left by internal support structures does not interfere with object function, at least some or all of the internal portion of the valley 1008 can be removed (indicated by broken lines), e.g., as previously discussed with respect to FIGS. 7A-9C. However, the removal may reduce the thickness of the object 1000 at or near the valley 1008, which may result in reduced stiffness and strength, and/or may increase the likelihood of object failure at the removal location. Moreover, in embodiments where the object 1000 is a dental appliance, the thinning of the valley 1008 may detrimentally affect the ability of the appliance to apply forces to the occlusal surfaces and/or other portions of the teeth.

Referring to FIG. 10B, the object 1000 can be modified to add additional material 1020 to compensate for the removed material, e.g., by reinforcing the object 1000 at or near the location of the removal. In the illustrated embodiment, for example, the additional material 1020 is added to the external surface of the object 1000 above the lowermost portion of the valley 1008. In other embodiments, the additional material 1020 can alternatively or additionally be added to other locations, such as to the external surface of the object 1000 proximate to the lowermost portion of the valley 1008, etc. Although FIG. 10B depicts the additional material 1020 as having a height corresponding to the height of a single layer 1004 of the object 1000, in other embodiments, the additional material 1020 can have a different height, such as a height less than the height of a single object layer 1004, a height greater than the height of a single object layer 1004, etc. The additional material 1020 can be the same as the material used to form the rest of the object 1000, or can be a different material.

In embodiments where the object 1000 is a dental appliance, the additional material 1020 can be used to redirect forces at or near the location of material removal, such that there is little or no difference in the overall forces provided by the appliance to the received teeth before and after modification. Moreover, the additional material 1020 can increase the strength of the appliance and/or redirect stresses away from the location of the material removal, thereby reducing the likelihood of the appliance warping, deforming, or otherwise exhibiting mechanical failure during post-processing and/or usage.

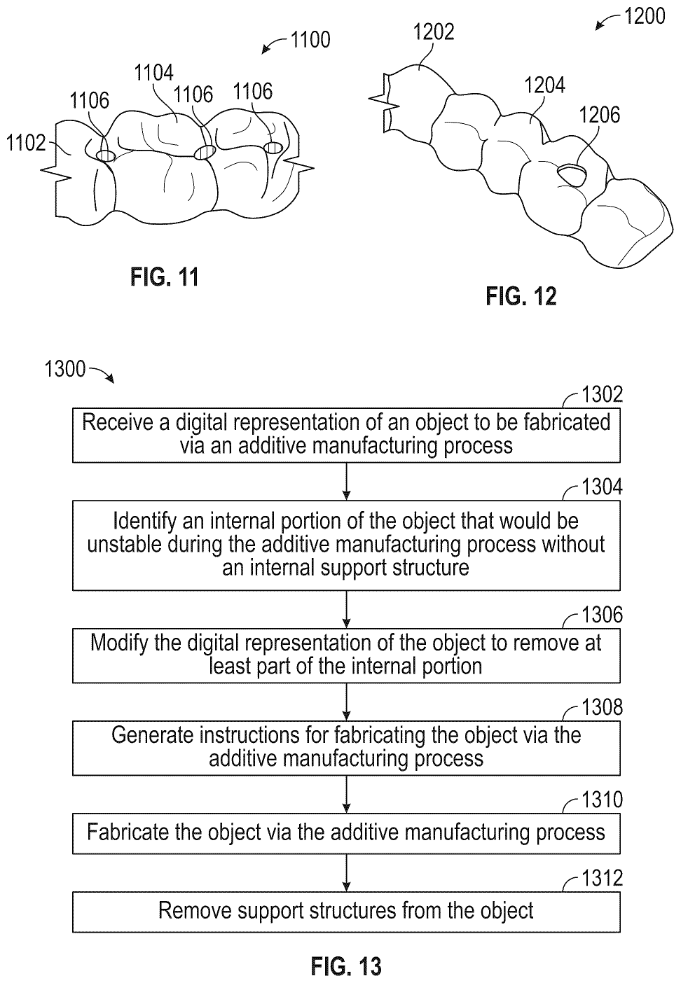

FIG. 11 is a perspective view of a portion of a dental appliance 1100 with modifications in accordance with embodiments of the present technology. The appliance 1100 includes a shell 1102 having an occlusal surface 1104. Material from the internal portions of the occlusal surface 1104 may be removed to reduce or obviate the need for internal support structures and/or to ensure that residue left by internal support structures does not interfere with object function, e.g., as previously discussed with respect to FIGS. 7A-9C. To compensate for the removal, additional material 1106 can be added to the external occlusal surface 1104 of the appliance 1100 at or proximate to the locations where material was removed, e.g., as previously discussed with respect to FIGS. 10A and 10B. For instance, additional material 1106 can be added at or near the interproximal regions of the shell 1102, and/or at or near the valleys in the shell 1102 corresponding to pits and/or fissures of the received teeth.

FIG. 12 is a perspective view of a portion of a dental appliance 1200 with modifications in accordance with embodiments of the present technology. The appliance 1200 includes a shell 1202 having an occlusal surface 1204. Material from the internal portions of the occlusal surface 1204 may be removed to reduce or obviate the need for internal support structures and/or to ensure that residue left by internal support structures does not interfere with object function, e.g., as previously discussed with respect to FIGS. 7A-9C. In some embodiments, the modifications can include completely removing certain portions of the occlusal surface 1204, thus leaving one or more holes 1206 in the shell 1202. The presence of the holes 1206 can provide various benefits, such as allowing for saliva exchange to counteract increases in acidity due to bacterial growth, thereby improving oral health and/or reducing the incidence of halitosis; and/or providing an exit for excess resin to escape from the interior or exterior of the appliance 1200 during centrifugal cleaning. To avoid compromising the integrity of the shell 1202, the shell 1202 can optionally be reinforced with additional material at or near the holes 1206, e.g., as previously discussed with respect to FIGS. 10A, 10B, and 11.

Although certain embodiments of FIGS. 7A-12 are described herein with respect to modifying the occlusal surface of a dental appliance, the techniques herein can alternatively or additionally be used to modify other portions of a dental appliance, such as a buccal surface or a lingual surface of the appliance. The surface(s) to be modified can be determined based on the orientation of the dental appliance relative to the build platform, the locations where internal support structures are present, etc.

FIG. 13 is a flow diagram illustrating a method 1300 for designing and fabricating an object, in accordance with embodiments of the present technology. The method 1300 can be used to design and fabricate any of the additively manufactured objects described herein, such as one or more dental appliances. In some embodiments, some or all of the processes of the method 1300 are implemented as computer-readable instructions (e.g., program code) that are configured to be executed by one or more processors of a computing device, such as a computing device of an appliance design system and/or an additive manufacturing system. The method 1300 can be combined with any of the other methods described herein, such as the method 100 of FIG. 1.

The method 1300 can begin at block 1302 with receiving a digital representation of an object to be fabricated via an additive manufacturing process. The digital representation can be a 3D model depicting the 3D geometry of the object. Alternatively or in combination, the digital representation can be a set of images depicting a plurality of cross-sections (e.g., layers) of the object, with each cross-section corresponding to an individual layer of the object for fabrication via a layer-by-layer additive manufacturing process (e.g., SLA or DLP). In some embodiments, the cross-sections are generated based on a 3D model of the object, e.g., by slicing the 3D model at a plurality of different vertical locations along the 3D model.

Optionally, the digital representation can be based on a prediction of the object geometry resulting from the additive manufacturing process. In some instances, the actual geometry of the fabricated object may differ from the target geometry for the object, e.g., due to phenomena such as light scattering, overcuring, deformation during additive manufacturing and/or post-processing, etc. For example, overcuring may cause the actual printed size of an object feature to be larger than its intended size. The predicted geometry can be determined in various ways, such as using simulations, experimental data, machine learning algorithms, rule-based algorithms, or combinations thereof. A digital representation that is based on the predicted geometry may provide better accuracy in identifying portions of the object that are likely to require internal support structures and/or in determining modifications to the object to reduce or omit such internal support structures.

At block 1304, the method 1300 can include identifying an internal portion of the object that would be unstable during the additive manufacturing process without an internal support structure, such as valleys, overhangs, etc., For instance, as described elsewhere herein, valleys in the object geometry may form islands that are disconnected from the rest of the object when the object is sliced into cross-sections, and thus may require internal support structures to be printable. As another example, long unsupported overhangs may sag, deform, or otherwise be challenging or impossible to print unless supported from below by an internal support structure.

The identification can be performed based on the digital representation in block 1302. For instance, the identification process can involve analyzing the geometry of the digital representation to detect the presence of valleys, overhangs, etc., at the internal portion of the object that are likely to be unstable during additive manufacturing without internal support structures. In embodiments where the digital representation includes a set of images depicting the cross-sections of the object, valleys in the object geometry may be identified by evaluating whether any of the images include any internal object regions that are completely disconnected from the remaining regions of the object (e.g., islands). Overhangs in the object geometry may be identified by evaluating whether any of the images include internal object regions that are connected to remaining regions of the object but have a length exceeding a maximum overhang length for the additive manufacturing process.

At block 1306, the method 1300 can include modifying the digital representation of the object to remove at least part of the internal portion. For instance, the internal portion can be completely deleted from the digital representation, such that the object can be fabricated without any internal support structures at that location, e.g., as previously described with respect to FIGS. 7A-8C. Alternatively, the internal portion can be only partially deleted from the digital representation, such that the object may still be fabricated with some internal support structures at that location, but the internal support structures can be trimmed from the object during post-processing without leaving residue that interferes with the function of the object, e.g., as previously described with respect to FIGS. 9A-9C. In embodiments where the digital representation includes a set of images depicting the cross-sections of the object, the modification can include deleting some or all of the internal object regions that were identified in block 1304 as being islands or overhangs from the images.

Optionally, the process of block 1306 can include making other types of modifications to the digital representation. For example, the digital representation can be modified to add additional material to the object, e.g., at or near the locations where the internal portion was removed. In some embodiments, the additional material is added to reinforce the object at or near the locations of material removal, e.g., as previously described with respect to FIGS. 10A-11. Alternatively or in combination, additional material may be added to stabilize certain internal portions of the object so that the internal portions can still be printed without being deleted and without requiring internal support structures. For example, if a disconnected island is detected in a particular object cross-section but is sufficiently close to the remaining regions of the object, material may be added to that cross-section to connect the island to the remaining regions (e.g., by dilating the contours of the island until they contact the remaining regions).

Optionally, in embodiments where the object is one of a pair of dental appliances to be worn on the upper and lower jaws of the patient, and a modification is made to an occlusal surface of one of the dental appliances, the process of block 1306 can additionally include making a corresponding modification to a mating occlusal surface of the other dental appliance. For example, if additional material is added to an external surface of one of the dental appliances (e.g., as described with respect to FIGS. 10A-11), some material may be removed from the corresponding external surface of the other dental appliance to accommodate the additional material. This approach can be used, for example, to ensure that changes to the dental appliance geometry do not interfere with the occlusion between the patient's upper and lower jaws.

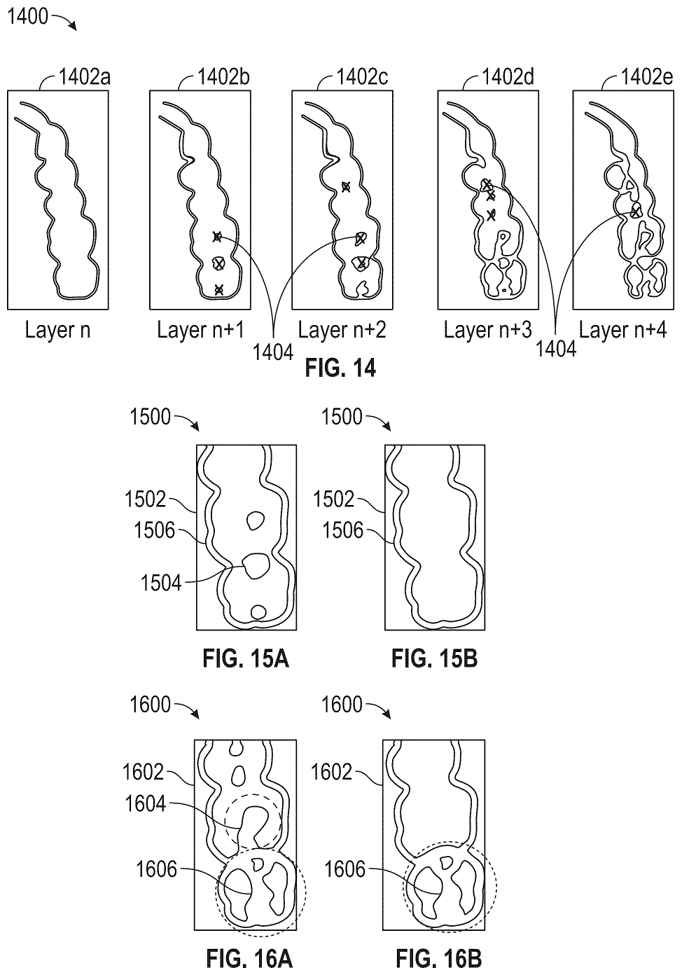

Additional examples and details of processes for identifying unstable object regions and modifying the digital representation of the object that may be used in blocks 1304 and 1306 are discussed further below in connection with FIGS. 14-18.

At block 1308, the method 1300 can continue with generating instructions for fabricating the object via the additive manufacturing process, based on the modified digital representation. The instructions can be any data type that can be used by an additive manufacturing system for fabricating the object. For example, the fabrication instructions can include the modified digital representation (e.g., modified images and/or 3D model), and/or can include other data generated based on the modified digital representation, such as a toolpath file (e.g., G-code file).

At block 1310, the method 1300 can include fabricating the object via the additive manufacturing process, based on the instructions. The additive manufacturing process can use any of the techniques described herein, such as SLA, DLP, etc. For instance, the additive manufacturing process can involve building up the object with the modified geometry in a layer-by-layer manner by sequentially applying energy to a curable material (e.g., a polymerizable resin), where the energy is applied in a pattern corresponding to the cross-sectional geometry of the particular object layer. The process of block 1310 can also include fabricating any support structures that are needed to connect the object to the build platform and support the object during printing. In embodiments where the object is a dental appliance, for example, the object can be fabricated in a cutline down configuration in which the gingival edges are connected to the build platform via one or more support structures. The internal portions of the dental appliance may not be connected to build platform with any internal support structures, or there may be some internal support structures connecting the internal portions to the build platform.

At block 1312, the method 1300 can optionally include removing support structures from the object. As described herein, the support structures may be removed by fracturing or otherwise trimming the support structures from the object. In some embodiments, the object does not include any internal support structures that need to be removed from the object. In some embodiments, the object includes some internal support structures, but the removal of the support structures does not leave any residue on the object that is expected to interfere with the object function. The object may or may not undergo additional post-processing (e.g., polishing) to remove support structure residue.

The method 1300 illustrated in FIG. 13 can be modified in many different ways. For example, although the above steps of the method 1300 are described with respect to a single object, the method 1300 can be used to sequentially or concurrently fabricate and post-process any suitable number of objects, such as tens, hundreds, or thousands of additively manufactured objects. As another example, the ordering of the processes shown in FIG. 13 can be varied. Some of the processes of the method 1300 can be omitted, such as the processes of blocks 1310 and/or 1312. Some of the processes can be performed by different entities, e.g., the processes of blocks 1302-1308 can be performed by an appliance design system, the process of block 1310 can be performed by an additive manufacturing system, and the process of block 1312 can be performed by a trimming system or by a human operator. Additionally, the method 1300 can include processes not shown in FIG. 13, such as additional post-processing of the object (e.g., removal of residual material after the object is fabricated and before the support structures are removed).

FIG. 14 illustrates identification and deletion of islands in a digital representation 1400 of a dental appliance, in accordance with embodiments of the present technology. The digital representation 1400 includes a series of images 1402a-1402e (collectively, “images 1402”) representing a plurality of layers of the appliance for fabrication via a layer-by-layer additive manufacturing process. In the illustrated embodiment, the images 1402 depict a plurality of layers for printing the appliance in a cutline down configuration, with earlier images 1402 in the series (e.g., image 1402a) representing lower layers near the gingival edges of the appliance, and later images 1402 in the series (e.g., image 1402e) representing higher layers near the occlusal surface of the appliance.

In the illustrated embodiment, some of the images 1402 include one or more islands 1404 that are disconnected from the remaining regions of the appliance. The islands 1404 can be identified, for example, by analyzing each image 1402 individually to detect pixels that are located within the interior of the appliance geometry and are not connected to any of the pixels of the external contour of the appliance geometry. These islands 1404 may correspond to valleys in the occlusal surface of the appliance that may require internal support structures for printing, as previously discussed. In some embodiments, the digital representation 1400 of the appliance is modified to delete some or all of the islands 1404 from the images 1402 (indicated by “X” marks in FIG. 14), thereby allowing the appliance to be fabricated with fewer or no internal support structures.

FIGS. 15A and 15B illustrate a digital representation 1500 of a dental appliance before (FIG. 15A) and after (FIG. 15B) modifications to delete islands, in accordance with embodiments of the present technology. Referring first to FIG. 15A, the digital representation 1500 includes an image 1502 representing an individual layer of the appliance for fabrication via a layer-by-layer additive manufacturing process. In the illustrated embodiment, the image 1502 includes three islands 1504 that are located within the interior of the appliance geometry and that are disconnected from the external contour 1506 of the appliance. The islands 1504 can correspond to valleys in the occlusal surface of the dental appliance, as discussed elsewhere herein. Referring next to FIG. 15B, the digital representation 1500 can be modified by deleting the islands 1504 from the image 1502 while leaving the external contour 1506 intact, thereby allowing the appliance to be printed without internal support structures.

FIGS. 16A and 16B illustrate a digital representation 1600 of a dental appliance before (FIG. 16A) and after (FIG. 16B) modifications to delete overhangs, in accordance with embodiments of the present technology. Referring first to FIG. 16A, the digital representation 1600 includes an image 1602 representing an individual layer of the appliance for fabrication via a layer-by-layer additive manufacturing process. In the illustrated embodiment, the image 1602 includes two overhangs 1604, 1606 that are located within the interior of the appliance geometry. The overhangs 1604, 1606 can correspond to valleys in the occlusal surface of the dental appliance, as discussed elsewhere herein.

Unlike islands, overhangs are connected to other regions of the appliance geometry. However, overhangs may still be unstable if they are too long, e.g., the unsupported portions of the overhang may sag, deform, collapse, etc., during printing and/or post-processing. In some embodiments, the digital representation 1600 is modified by deleting overhangs that exceed a maximum overhang length for printability. The maximum overhang length may depend on whether the overhang is a “disconnected overhang” or a “connected overhang,” e.g., connected overhangs can be longer than disconnected overhangs. For example, the maximum overhang length for a disconnected overhang can be up to 10 mm, 8 mm, or 5 mm, while the maximum overhang length for a connected overhang can be up to 15 mm, 12 mm, or 10 mm.

In the illustrated embodiment, the overhang 1604 is considered a disconnected overhang in that one end of the overhang 1604 is not connected to any other regions of the appliance geometry, while the overhang 1606 is considered a connected overhang in that both ends of the overhang 1606 are connected to other regions of the appliance geometry. If the length of the overhang 1604 exceeds the maximum overhang length for a disconnected overhang, the overhang 1604 can be deleted from the image 1602 (FIG. 16B) so that the appliance can be printed without requiring an internal support structure for the overhang 1604. Conversely, if the length of the overhang 1606 is less than the maximum overhang length for a connected overhang, the overhang 1606 can be retained in the image 1602 and the appliance can be printed without requiring an internal support structure for the overhang 1606.

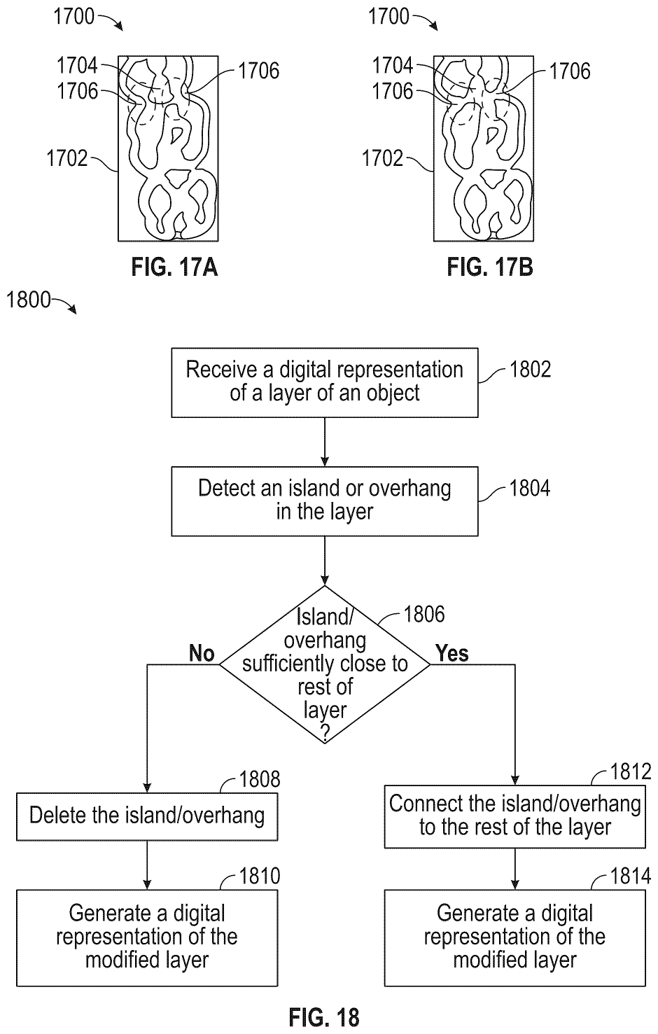

FIGS. 17A and 17B illustrate a digital representation 1700 of a dental appliance before (FIG. 17A) and after (FIG. 17B) modifications to eliminate disconnected overhangs, in accordance with embodiments of the present technology. Referring first to FIG. 17A, the digital representation 1700 includes an image 1702 representing an individual layer of the appliance for fabrication via a layer-by-layer additive manufacturing process. In the illustrated embodiment, the image 1702 includes an overhang 1704 that is located within the interior of the appliance geometry. The overhang 1704 can be considered to be a disconnected overhang since only one end of the overhang 1704 is connected to the rest of the appliance geometry, while the other end is disconnected. Thus, the overhang 1704 may be unstable if the length of the overhang 1704 exceeds the maximum overhang length for a disconnected overhang.

Referring next to FIG. 17B, in some embodiments, rather than deleting the overhang 1704, the overhang 1704 can be preserved in the appliance geometry if the overhang 1704 is sufficiently close to other regions of the appliance (e.g., within 1 mm, 500 μm, 200 μm, 100 μm, or 50 μm). In the illustrated embodiment, for example, the size of the overhang 1704 can be expanded to connect the overhang 1704 to neighboring regions 1706 of the appliance, thereby converting the overhang 1704 into a connected overhang, which may have a longer maximum overhang length as discussed above. This approach can be used in situations where the expansion of the overhang 1704 is not expected to interfere with the fit and function of the appliance.

FIG. 18 is a flow diagram illustrating a method 1800 for modifying a digital representation of an object, in accordance with embodiments of the present technology. The method 1800 can be used to design any of the additively manufactured objects described herein, such as one or more dental appliances. In some embodiments, some or all of the processes of the method 1800 are implemented as computer-readable instructions (e.g., program code) that are configured to be executed by one or more processors of a computing device, such as a computing device of an appliance design system. The method 1800 can be combined with any of the other methods described herein, such as the method 100 of FIG. 1 and/or the method 1300 of FIG. 13.

The method 1800 can begin at block 1802 with receiving a digital representation of layer of an object. For example, the digital representation can be an image (e.g., a PNG image, a BMP image) depicting the cross-sectional geometry of the object layer for fabrication via a layer-by-layer additive manufacturing process.

At block 1804, the method 1800 can include detecting whether an island or overhang is present in the layer. Islands may be detected by analyzing an image of the layer to detect groups of pixels that are located within the interior of the object and that are not connected to any other pixels in the object. Overhangs may be detected by analyzing an image of the layer to detect groups of pixels that are connected to other pixels in the object at a single end only (e.g., a disconnected overhang) or at two or more ends (e.g., a connected overhang), and that exceed a maximum permissible length for that particular type of overhang.

At block 1806, if an island/overhang is detected, the method 1800 can determine whether the island/overhang is sufficiently close to the rest of the object in that same layer to be reconnected. For instance, the distance between the outer edges of the island/overhang and the neighboring regions of the object can be measured and compared to a threshold value.

If the island/overhang is not sufficiently close (e.g., the distance exceeds the threshold value at all locations on the outer edges of the island/overhang), this may indicate that the island/overhang cannot be connected to the rest of the object. Accordingly, the method 1800 can proceed to block 1808 with deleting the island/overhang from the layer, and then to block 1810 to generate a digital representation of the modified layer (e.g., an image in which the island/overhang has been deleted).

If the island/overhang is sufficiently close (e.g., the distance is less than the threshold value at one or more locations on the outer edges of the island/overhang), this may indicate that the island/overhang can be connected to the rest of the object to obviate the need for internal support structures during printing of the island/overhang. Accordingly, the method 1800 can proceed to block 1812 to connect the island/overhang to neighboring regions of the object, e.g., by adding pixels to expand the size of the island/overhang. The method 1800 can then proceed to block 1814 to generate a digital representation of the modified layer (e.g., an image in which the island/overhang has been connected).

The method 1800 can be repeated for each layer of the object to check for islands and/or overhangs in the object, and to modify the layer to delete or reconnect the islands and/or overhangs, as appropriate. The output of the method 1800 can be a digital representation of the entire object geometry with modifications to ensure that the object can be printed with fewer or no internal support structures.

The method 1800 illustrated in FIG. 18 can be modified in many different ways. For example, the method 1800 can include processes not shown in FIG. 18, such as a process for checking for and filling in holes in an object layer that are not intended to be present in the final object. Such a process may be performed before, concurrently with, or after other modifications to the layer (e.g., deletion or connection of an island/overhang).

In some embodiments, when determining how to modify an additively manufactured dental appliance to avoid unstable internal portions, it may be advantageous to modify a digital representation of a patient's teeth that is to be used to determine the geometry of the dental appliance, as an alternative or in addition to modifying a digital representation of the dental appliance itself. This approach may be advantageous, for example, to preserve the original thickness of the dental appliance as much as possible, which in turn may affect the manufacturability and performance of the dental appliance.

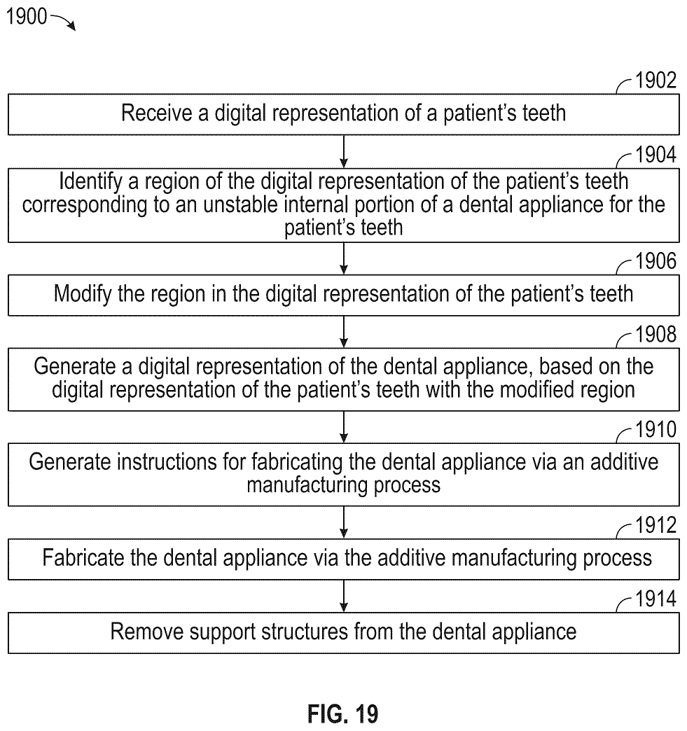

FIG. 19 is a flow diagram illustrating a method 1900 for designing and fabricating dental appliance, in accordance with embodiments of the present technology. In some embodiments, some or all of the processes of the method 1900 are implemented as computer-readable instructions (e.g., program code) that are configured to be executed by one or more processors of a computing device, such as a computing device of an appliance design system and/or an additive manufacturing system. The method 1900 can be combined with any of the other methods described herein, such as the method 100 of FIG. 1, the method 1300 of FIG. 13, and/or the method 1800 of FIG. 18.

The method 1902 can begin at block 1902 with receiving a digital representation of a patient's teeth. The digital representation may be a 3D digital model (e.g., a surface model, a solid model, a mesh model, a parametric model) representing one or more teeth of the patient's upper or lower dental arch. The digital representation can include or be based on scan data (e.g., intraoral and/or extraoral scans of the patient's teeth and/or of impressions of the teeth), magnetic resonance imaging (MRI) data, radiographic data (e.g., standard x-ray data such as bitewing x-ray data, panoramic x-ray data, cephalometric x-ray data, computed tomography (CT) data, cone-beam computed tomography (CBCT) data, fluoroscopy data), photographs, video, or any other data type that depicts features of interest of the intraoral cavity.

The digital representation may depict the teeth in an initial (e.g., pre-treatment arrangement). Alternatively, the digital representation may depict the teeth in an intermediate or target arrangement specified by a treatment plan for the patient's teeth. For example, the treatment plan can include sequentially applying a series of dental appliances (e.g., aligners, palatal expanders) to the patient's dentition to incrementally reposition the teeth from the initial arrangement toward the target arrangement through a series of intermediate arrangements, and/or to maintain the teeth in the target arrangement.

At block 1904, the method 1900 can continue with identifying a region of the digital representation of the patient's teeth corresponding to an unstable internal portion of a dental appliance for the patient's teeth. As described elsewhere herein, the unstable internal portion may be an internal portion of the dental appliance that would be unstable during an additive manufacturing process without an internal support structure, such as valleys, overhangs, island, etc. For example, in embodiments where the dental appliance includes a shell having a plurality of cavities to receive the patient's teeth, the occlusal surfaces of the shell may conform closely to the contours of the occlusal surfaces of the received teeth. If the occlusal surfaces include concavities such as pits and/or fissures, the resulting shell may also include corresponding concavities that would be unstable without support during additive manufacturing.

The region of the digital representation of the patient's teeth corresponding to the unstable internal portion of the dental appliance may be identified in various ways. In some embodiments, the region is identified by analyzing the geometry of the digital representation to detect the location and/or depth of concavities, e.g., concavities having a depth that exceeds a threshold value may be identified as being a region corresponding to an unstable internal portion. Alternatively or in addition, the region may be identified by generating cross-sections (e.g., slices) of the digital representation of the patient's teeth, and then identifying the locations of island, valleys, overhands, etc., in the cross-sections.

At block 1906, the method 1900 can include modifying the region in the digital representation of the patient's teeth. The modification can include reducing or eliminating concavities that are present in the region, such as by smoothing out the concavities and/or adding additional material to the concavities to reduce their depth. In some embodiments, the modification is configured to eliminate the need for internal support structures at the corresponding internal portion of the dental appliance, e.g., similar to the embodiments of FIGS. 7A-8C. Alternatively, the modification is configured so that the dental appliance may still be fabricated with some internal support structures at that location, but the internal support structures can be trimmed from the dental appliance during post-processing without leaving residue that interferes with the function of the dental appliance, e.g., similar to the embodiments of FIGS. 9A-9C.

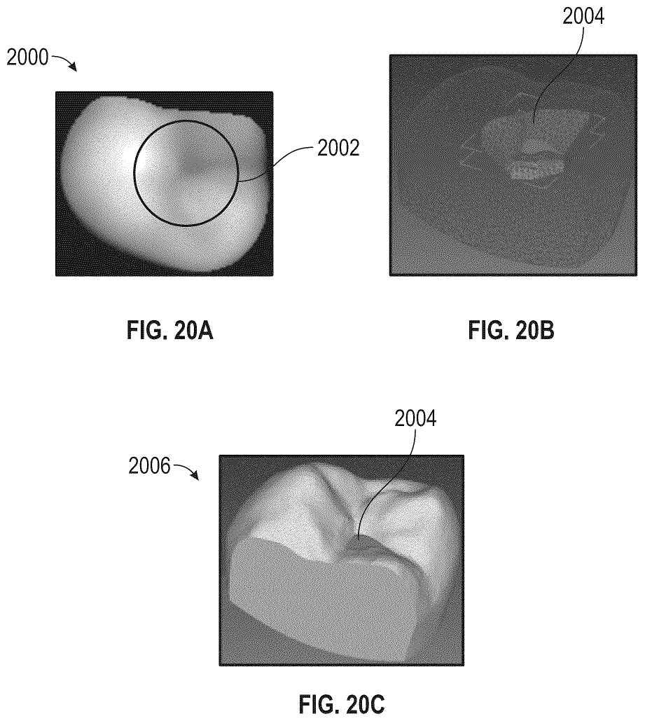

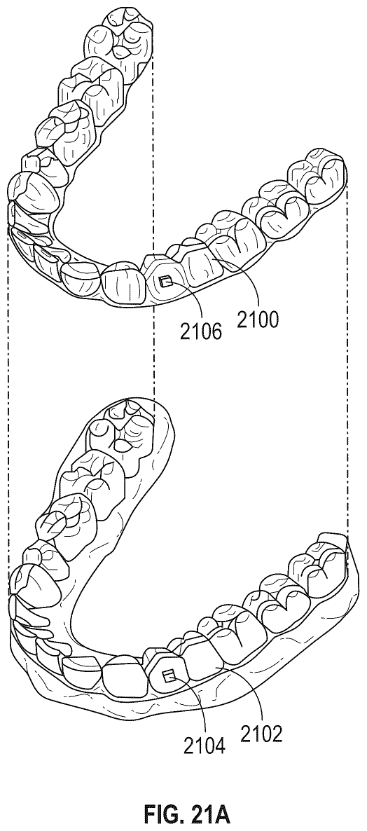

For example, FIGS. 20A-20C illustrate a workflow for modifying a digital representation of a patient's teeth, in accordance with embodiments of the present technology. Referring first to FIG. 20A, a height map 2000 of the teeth can be created from a digital representation of the teeth, with the different values in the height map representing the height (or depth) of different locations on the teeth. The height map 2000 can be analyzed to identify a region 2002 corresponding to an unstable internal portion of a dental appliance, such as a region including a concavity that exceeds a predetermined depth threshold. Referring next to FIG. 20B, a filler object 2004 can be generated that, when applied to the region 2002, reduces or eliminates the concavity that would produce the unstable internal portion. For instance, the filler object 2004 may reduce the depth of the concavity to be less than the predetermined depth threshold. Optionally, the filler object 2004 may also be generated based on a digital representation of teeth in the opposing jaw of the patient, e.g., the geometry of the filler object 2004 may be designed to avoid interfering with occlusion between the upper and lower jaws. Referring next to FIG. 20C, the filler object 2004 can be applied to a digital representation 2006 of the teeth to produce a modified digital representation of the teeth. The modified digital representation can then be used to determine a geometry for the dental appliance.

Referring again to FIG. 19, the process of block 1906 can alternatively or additionally use other techniques for modifying the region of the digital representation of the teeth. For instance, a smoothing function such as a rolling ball algorithm may be applied to the region of the digital representation to smooth out and/or reduce the depth of concavities that are present. As another example, the height of the tooth surface of the region may be increased by a specified amount (e.g., by a distance corresponding to the layer height of one or more additively manufactured layers).

At block 1908, the method 1900 can include generating a digital representation of the dental appliance, based on the digital representation of the patient's teeth with the modified region. For instance, the digital representation of the dental appliance can include a shell with internal surfaces that generally conform to the surfaces of the digital representation of the teeth. The digital representation can be a 3D model depicting the 3D geometry of the dental appliance. Alternatively or in combination, the digital representation can be a set of images depicting a plurality of cross-sections (e.g., layers) of the dental appliance, with each cross-section corresponding to an individual layer of the dental appliance for fabrication via a layer-by-layer additive manufacturing process (e.g., SLA or DLP). In some embodiments, the cross-sections are generated based on a 3D model of the dental appliance, e.g., by slicing the 3D model at a plurality of different vertical locations along the 3D model.

Optionally, the process of block 1908 can further include analyzing the digital representation of the dental appliance to identify any unstable internal portions that are still present, and modifying the digital representation to remove such unstable internal portions, as previously described with respect to blocks 1304 and 1306 of the method 1300 of FIG. 13.

At block 1910, the method 1900 can continue with generating instructions for fabricating the dental appliance via an additive manufacturing process, based on the digital representation of the dental appliance. The instructions can be any data type that can be used by an additive manufacturing system for fabricating the dental appliance. For example, the fabrication instructions can include the digital representation (e.g., images and/or 3D model), and/or can include other data generated based on the digital representation, such as a toolpath file (e.g., G-code file).

At block 1912, the method 1900 can include fabricating the dental appliance via the additive manufacturing process, based on the instructions. The additive manufacturing process can use any of the techniques described herein, such as SLA, DLP, etc. For instance, the additive manufacturing process can involve building up the dental appliance with the modified geometry in a layer-by-layer manner by sequentially applying energy to a curable material (e.g., a polymerizable resin), where the energy is applied in a pattern corresponding to the cross-sectional geometry of the particular object layer. The process of block 1912 can also include fabricating any support structures that are needed to connect the dental appliance to the build platform and support the dental appliance during printing. The internal portions of the dental appliance may not be connected to build platform with any internal support structures, or there may be some internal support structures connecting the internal portions to the build platform.

At block 1914, the method 1900 can optionally include removing support structures from the dental appliance. As described herein, the support structures may be removed by fracturing or otherwise trimming the support structures from the dental appliance. In some embodiments, the object does not include any internal support structures that need to be removed from the dental appliance. In some embodiments, the dental appliance includes some internal support structures, but the removal of the support structures does not leave any residue on the dental appliance that is expected to interfere with the function of the dental appliance. The dental appliance may or may not undergo additional post-processing (e.g., polishing) to remove support structure residue.

The method 1900 illustrated in FIG. 19 can be modified in many different ways. For example, although the above steps of the method 1900 are described with respect to a single dental appliance, the method 1900 can be used to sequentially or concurrently fabricate and post-process any suitable number of dental appliances, such as tens, hundreds, or thousands of additively manufactured dental appliances. As another example, the ordering of the processes shown in FIG. 19 can be varied. Some of the processes of the method 1900 can be omitted, such as the processes of blocks 1912 and/or 1914. Some of the processes can be performed by different entities, e.g., the processes of blocks 1902-1910 can be performed by an appliance design system, the process of block 1912 can be performed by an additive manufacturing system, and the process of block 1914 can be performed by a trimming system or by a human operator. Additionally, the method 1900 can include processes not shown in FIG. 19, such as additional post-processing of the dental appliance (e.g., removal of residual material after the dental appliance is fabricated and before the support structures are removed).

### II. Dental Appliances and Associated Methods

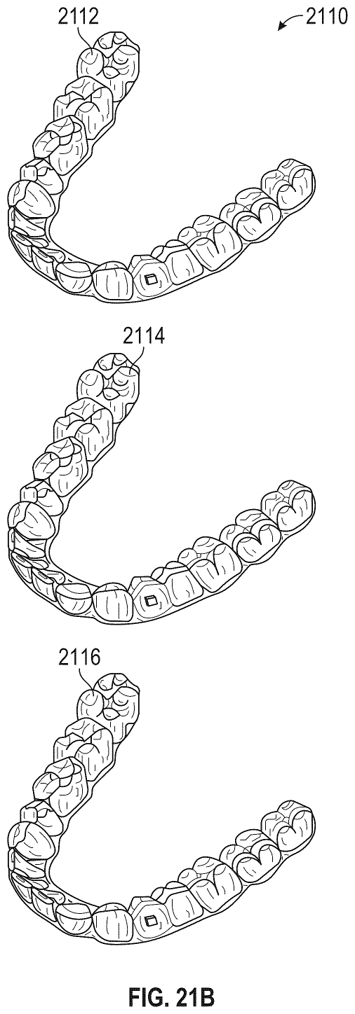

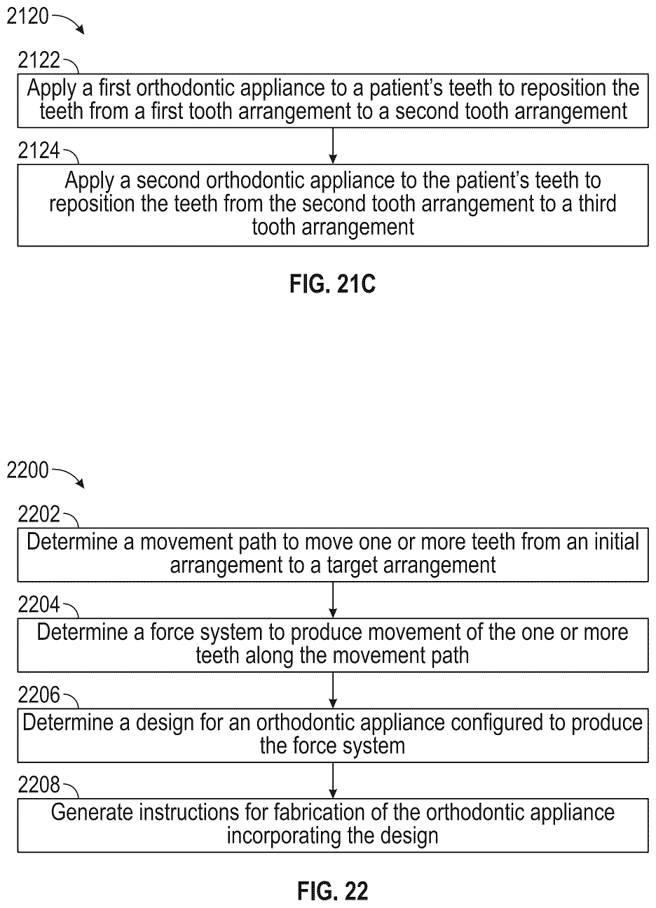

FIG. 21A illustrates a representative example of a tooth repositioning appliance 2100 configured in accordance with embodiments of the present technology. The appliance 2100 can be manufactured using any of the systems, methods, and devices described herein. The appliance 2100 (also referred to herein as an “aligner”) can be worn by a patient in order to achieve an incremental repositioning of individual teeth 2102 in the jaw. The appliance 2100 can include a shell (e.g., a continuous polymeric shell or a segmented shell) having teeth-receiving cavities that receive and resiliently reposition the teeth. The appliance 2100 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 2100 can fit over all teeth present in an upper or lower jaw, or less than all of the teeth. The appliance 2100 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 2100 can be a generic appliance configured to receive the teeth, but not necessarily shaped to match the topography of the patient's teeth. In some cases, only certain teeth received by the appliance 2100 are repositioned by the appliance 2100 while other teeth can provide a base or anchor region for holding the appliance 2100 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 2100 in place over the teeth. In some cases, however, it may be desirable or necessary to provide individual attachments 2104 or other anchoring elements on teeth 2102 with corresponding receptacles 2106 or apertures in the appliance 2100 so that the appliance 2100 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 21B illustrates a tooth repositioning system 2110 including a plurality of appliances 2112, 2114, 2116, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 2110 can include a first appliance 2112 corresponding to an initial tooth arrangement, one or more intermediate appliances 2114 corresponding to one or more intermediate arrangements, and a final appliance 2116 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 21C illustrates a method 2120 of orthodontic treatment using a plurality of appliances, in accordance with embodiments of the present technology. The method 2120 can be practiced using any of the appliances or appliance sets described herein. In block 2122, a first orthodontic appliance is applied to a patient's teeth in order to reposition the teeth from a first tooth arrangement to a second tooth arrangement. In block 2124, a second orthodontic appliance is applied to the patient's teeth in order to reposition the teeth from the second tooth arrangement to a third tooth arrangement. The method 2120 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 22 illustrates a method 2200 for designing an orthodontic appliance, in accordance with embodiments of the present technology. The method 2200 can be applied to any embodiment of the orthodontic appliances described herein. Some or all of the steps of the method 2200 can be performed by any suitable data processing system or device, e.g., one or more processors configured with suitable instructions.

In block 2202, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 2204, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 2204 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 2206, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 2208, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 2200 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 2200 may be performed with any suitable fabrication system or device, such as the embodiments described herein. Some of the steps may be optional, e.g., the process of block 2204 can be omitted, such that the orthodontic appliance is designed based on the desired tooth movements and/or determined tooth movement path, rather than based on a force system. Moreover, the order of the steps can be varied as desired.

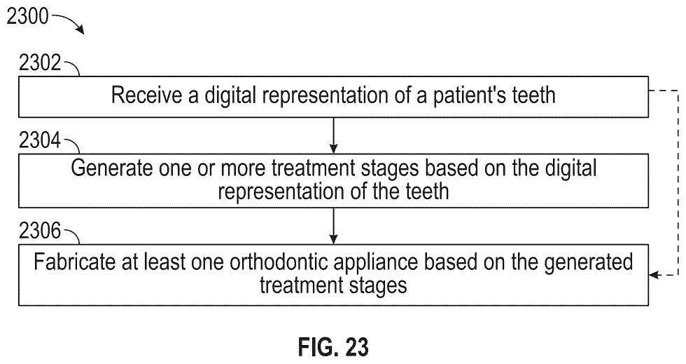

FIG. 23 illustrates a method 2300 for digitally planning an orthodontic treatment and/or design or fabrication of an appliance, in accordance with embodiments. The method 2300 can be applied to any of the treatment procedures described herein and can be performed by any suitable data processing system.

In block 2302, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 2304, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 2306, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 23, design and/or fabrication of an orthodontic appliance, and perhaps a particular orthodontic treatment, may include use of a representation of the patient's teeth (e.g., including receiving a digital representation of the patient's teeth (block 2302)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.
Example 1. A method comprising:
receiving a digital representation of an object to be fabricated via an additive manufacturing process;
identifying an internal portion of the object that would be unstable during the additive manufacturing process without an internal support structure, based on the digital representation;
modifying the digital representation of the object to remove at least part of the internal portion; and
generating instructions for fabricating the object via the additive manufacturing process, based on the modified digital representation.
Example 2. The method of Example 1, wherein the internal portion is an overhang or valley in the object.
Example 3. The method of Example 1 or 2, wherein the internal portion comprises a first region of a first layer of the object that is disconnected from or insufficiently connected to a remaining region of the first layer of the object.
Example 4. The method of Example 3, wherein the digital representation of the object is modified to remove the first region of the first layer.
Example 5. The method of Example 3 or 4, wherein:
the internal portion comprises a second region of a second layer of the object that is disconnected from or insufficiently connected to a remaining region of the second layer of the object,
the second layer is located above the first layer, and
the second region is not removed during the modifying of the digital representation.
Example 6. The method of Example 5, wherein the instructions are configured to cause the object to be fabricated with an internal support structure connected to the second region.
Example 7. The method of any one of Examples 1 to 6, wherein the internal portion is entirely removed.
Example 8. The method of any one of Examples 1 to 6, wherein the internal portion is only partially removed.
Example 9. The method of Example 1, wherein modifying the digital representation further comprises adding additional material to an external portion of the object to compensate for the removal.
Example 10. The method of any one of Examples 1 to 9, wherein identifying the internal portion comprises:
generating a plurality of cross-sections of the object, wherein the plurality of cross-sections represent a plurality of material layers for forming the object via the additive manufacturing process, and
identifying a region of the object in at least one cross-section that is disconnected from remaining regions of the object in the at least one cross-section.
Example 11. The method of any one of Examples 1 to 10, wherein identifying the internal portion comprises:
generating a plurality of cross-sections of the object, wherein the plurality of cross-sections represent a plurality of material layers for forming the object via the additive manufacturing process, and
identifying a region of the object in at least one cross-section having an overhang size greater than a threshold value.
Example 12. The method of Example 10 or 11, wherein the digital representation is modified by deleting the identified region in the at least one cross-section.
Example 13. The method of any one of Examples 1 to 12, wherein the object is a dental appliance comprising a shell defining a plurality of teeth-receiving cavities.
Example 14. The method of Example 13, wherein the internal portion is located at an occlusal surface of the shell.
Example 15. The method of Example 13 or 14, wherein the shell comprises a gingival edge, and wherein the instructions are configured to cause the dental appliance to be fabricated with one or more support structures connecting the gingival edge to a build platform.
Example 16. The method of any one of Examples 13 to 15, further comprising determining whether the internal portion is configured to apply force to a patient's tooth, wherein the modifying is performed in response to a determination that the internal portion is not configured to apply force to the patient's tooth.
Example 17. The method of any one of Examples 13 to 16, further comprising determining whether the internal portion is configured to contact a patient's tooth, wherein the modifying is performed in response to a determination that the internal portion is not configured to contact the patient's tooth.
Example 18. The method of any one of Examples 13 to 17, wherein the instructions are configured to cause the dental appliance to be fabricated with an internal support structure connected to a remaining part of the internal portion.
Example 19. The method of Example 18, wherein the internal support structure is configured to be fractured, and wherein an amount of support structure residue left on the dental appliance after the fracturing does not contact any of the patient's teeth when the dental appliance is worn.
Example 20. The method of any one of Examples 1 to 19, wherein the additive manufacturing process comprises forming the object from a plurality of cured material layers.
Example 21. A system comprising:
one or more processors; and
a memory operably coupled to the one or more processors and storing instructions that, when executed by the one or more processors, cause the system to perform operations comprising:
   receiving a digital representation of an object to be fabricated via an additive manufacturing process,
   identifying an internal portion of the object that would be unstable during the additive manufacturing process without an internal support structure, based on the digital representation,
   modifying the digital representation of the object to remove at least part of the internal portion, and
   generating fabrication instructions for forming the object via the additive manufacturing process, based on the modified digital representation.
Example 22. The system of Example 21, wherein the internal portion is an overhang or valley in the object.
Example 23. The system of Example 21 or 22, wherein the internal portion comprises a first region of a first layer of the object that is disconnected from or insufficiently connected to a remaining region of the first layer of the object.
Example 24. The system of Example 23, wherein the digital representation of the object is modified to remove the first region of the first layer.
Example 25. The system of Example 23 or 24, wherein:
the internal portion comprises a second region of a second layer of the object that is disconnected from or insufficiently connected to a remaining region of the second layer of the object,
the second layer is located above the first layer, and
the second region is not removed during the modifying of the digital representation.
Example 26. The system of Example 25, wherein the fabrication instructions are configured to cause the object to be fabricated with an internal support structure connected to the second region.
Example 27. The system of any one of Examples 21 to 26, wherein the internal portion is entirely removed.
Example 28. The system of any one of Examples 21 to 26, wherein the internal portion is only partially removed.
Example 29. The system of any one of Examples 21 to 28, wherein modifying the digital representation further comprises adding additional material to an external portion of the object to compensate for the removal.
Example 30. The system of any one of Examples 21 to 29, wherein identifying the internal portion comprises:
generating a plurality of cross-sections of the object, wherein the plurality of cross-sections represent a plurality of material layers for forming the object via the additive manufacturing process, and
identifying a region of the object in at least one cross-section that is disconnected from remaining regions of the object in the at least one cross-section.
Example 31. The system of any one of Examples 21 to 30, wherein identifying the internal portion comprises:
generating a plurality of cross-sections of the object, wherein the plurality of cross-sections represent a plurality of material layers for forming the object via the additive manufacturing process, and
identifying a region of the object in at least one cross-section having an overhang size greater than a threshold value.
Example 32. The system of Example 30 or 31, wherein the object is modified by deleting the identified region in the at least one cross-section.
Example 33. The system of any one of Examples 21 to 32, wherein the object is a dental appliance comprising a shell defining a plurality of teeth-receiving cavities.
Example 34. The system of Example 33, wherein the internal portion is located at an occlusal surface of the shell.
Example 35. The system of Example 33 or 34, wherein the shell comprises a gingival edge, and wherein the fabrication instructions are configured to cause the dental appliance to be fabricated with one or more support structures connecting the gingival edge to a build platform.
Example 36. The system of any one of Examples 33 to 35, wherein the operations further comprise determining whether the internal portion is configured to apply force to a patient's tooth, wherein the modifying is performed in response to a determination that the internal portion is not configured to apply force to the patient's tooth.
Example 37. The system of any one of Examples 33 to 36, wherein the operations further comprise determining whether the internal portion is configured to contact a patient's tooth, wherein the modifying is performed in response to a determination that the internal portion is not configured to contact the patient's tooth.
Example 38. The system of any one of Examples 33 to 37, wherein the fabrication instructions are configured to cause the dental appliance to be formed with an internal support structure connected to a remaining part of the internal portion.
Example 39. The system of Example 38, wherein the internal support structure is configured to be fractured, and wherein an amount of support structure residue left on the dental appliance after the fracturing does not contact any of the patient's teeth when the dental appliance is worn.
Example 40. The system of any one of Examples 21 to 39, wherein the additive manufacturing process comprises forming the object from a plurality of cured material layers.
Example 41. A method comprising:
receiving a digital representation of a patient's teeth;
identifying a region of the digital representation of the patient's teeth corresponding to an unstable internal portion of a dental appliance for the patient's teeth;
modifying the region in the digital representation of the patient's teeth;
generating a digital representation of the dental appliance, based on the digital representation of the patient's teeth with the modified region; and
generating instructions for fabricating the dental appliance via an additive manufacturing process, based on the digital representation of the dental appliance.
Example 42. The method of Example 41, wherein the region is a concavity in a surface of the patient's teeth.
Example 43. The method of Example 41 or 42, wherein the internal portion is an overhang or valley in the dental appliance.
Example 44. The method of any one of Examples 41 to 43, wherein modifying the region comprises smoothing the region.
Example 45. The method of any one of Examples 41 to 44, wherein modifying the region comprises adding a filler object to the region.
Example 46. The method of any one of Examples 41 to 45, wherein modifying the region comprises increasing a height of the region.
Example 47. The method of any one of Examples 41 to 46, wherein the modification is configured to eliminate the unstable internal portion in the dental appliance.
Example 48. The method of any one of Examples 41 to 46, wherein the modification is configured to prevent residue from an internal support structure at the unstable internal portion from interfering with fitting of the dental appliance on the patient's teeth.
Example 49. The method of any one of Examples 41 to 48, wherein the additive manufacturing process comprises forming the dental appliance from a plurality of cured material layers.
Example 50. The method of any one of Examples 41 to 49, further comprising fabricating the dental appliance via the additive manufacturing process.
Example 51. A system comprising:
one or more processors; and
a memory operably coupled to the one or more processors and storing instructions that,
   when executed by the one or more processors, cause the system to perform operations comprising:
   receiving a digital representation of a patient's teeth,
   identifying a region of the digital representation of the patient's teeth corresponding to an unstable internal portion of a dental appliance for the patient's teeth,
   modifying the region in the digital representation of the patient's teeth,
   generating a digital representation of the dental appliance, based on the digital representation of the patient's teeth with the modified region, and
   generating instructions for fabricating the dental appliance via an additive manufacturing process, based on the digital representation of the dental appliance.
Example 52. The system of Example 51, wherein the region is a concavity in a surface of the patient's teeth.
Example 53. The system of Example 51 or 52, wherein the internal portion is an overhang or valley in the dental appliance.
Example 54. The system of any one of Examples 51 to 53, wherein modifying the region comprises smoothing the region.
Example 55. The system of any one of Examples 51 to 54, wherein modifying the region comprises adding a filler object to the region.
Example 56. The system of any one of Examples 51 to 55, wherein modifying the region comprises increasing a height of the region.
Example 57. The system of any one of Examples 51 to 56, wherein the modification is configured to eliminate the unstable internal portion in the dental appliance.
Example 58. The system of any one of Examples 51 to 56, wherein the modification is configured to prevent residue from an internal support structure at the unstable internal portion from interfering with fitting of the dental appliance on the patient's teeth.
Example 59. The system of any one of Examples 51 to 58, wherein the additive manufacturing process comprises forming the dental appliance from a plurality of cured material layers.
Example 60. The system of any one of Examples 51 to 59, wherein the operations further comprise fabricating the dental appliance via the additive manufacturing process.
Example 61. A non-transitory computer-readable storage medium comprising instructions that, when executed by one or more processors of a computing system, cause the computing system to perform operations comprising the method of any one of Examples 1 to 20 or 41 to 50.

### CONCLUSION

Although many of the embodiments are described above with respect to systems, devices, and methods for designing and manufacturing dental appliances, the technology is applicable to other applications and/or other approaches, such as the design and manufacture of other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-23.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
receiving a digital representation of an object to be fabricated via an additive manufacturing process;
identifying an internal portion of the object that would be unstable during the additive manufacturing process without an internal support structure, based on the digital representation;
modifying the digital representation of the object to remove at least part of the internal portion; and
generating instructions for fabricating the object via the additive manufacturing process, based on the modified digital representation.

2. The method of claim 1, wherein the internal portion is an overhang or valley in the object.

3. The method of claim 1, wherein the internal portion comprises a first region of a first layer of the object that is disconnected from or insufficiently connected to a remaining region of the first layer of the object.

4. The method of claim 3, wherein the digital representation of the object is modified to remove the first region of the first layer.

5. The method of claim 3, wherein:
the internal portion comprises a second region of a second layer of the object that is disconnected from or insufficiently connected to a remaining region of the second layer of the object,
the second layer is located above the first layer, and
the second region is not removed during the modifying of the digital representation.

6. The method of claim 5, wherein the instructions are configured to cause the object to be fabricated with an internal support structure connected to the second region.

7. The method of claim 1, wherein the internal portion is entirely removed.

8. The method of claim 1, wherein the internal portion is only partially removed.

9. The method of claim 1, wherein modifying the digital representation further comprises adding additional material to an external portion of the object to compensate for the removal.

10. The method of claim 1, wherein identifying the internal portion comprises:
generating a plurality of cross-sections of the object, wherein the plurality of cross-sections represent a plurality of material layers for forming the object via the additive manufacturing process, and
identifying a region of the object in at least one cross-section that is disconnected from remaining regions of the object in the at least one cross-section.

11. The method of claim 1, wherein identifying the internal portion comprises:
generating a plurality of cross-sections of the object, wherein the plurality of cross-sections represent a plurality of material layers for forming the object via the additive manufacturing process, and
identifying a region of the object in at least one cross-section having an overhang size greater than a threshold value.

12. The method of claim 10, wherein the digital representation is modified by deleting the identified region in the at least one cross-section.

13. The method of claim 1, wherein the object is a dental appliance comprising a shell defining a plurality of teeth-receiving cavities.

14. The method of claim 13, wherein the internal portion is located at an occlusal surface of the shell.

15. The method of claim 13, wherein the shell comprises a gingival edge, and wherein the instructions are configured to cause the dental appliance to be fabricated with one or more support structures connecting the gingival edge to a build platform.

16. The method of claim 13, further comprising determining whether the internal portion is configured to apply force to a patient's tooth, wherein the modifying is performed in response to a determination that the internal portion is not configured to apply force to the patient's tooth.

17. The method of claim 13, further comprising determining whether the internal portion is configured to contact a patient's tooth, wherein the modifying is performed in response to a determination that the internal portion is not configured to contact the patient's tooth.

18. The method of claim 13, wherein the instructions are configured to cause the dental appliance to be fabricated with an internal support structure connected to a remaining part of the internal portion.

19. The method of claim 18, wherein the internal support structure is configured to be fractured, and wherein an amount of support structure residue left on the dental appliance after the fracturing does not contact any of the patient's teeth when the dental appliance is worn.

20. The method of claim 1, wherein the additive manufacturing process comprises forming the object from a plurality of cured material layers.
